(19) United States
(12) Patent Application Publication
(10) Pub. No.: US 2026/0236267 A1
(43) Pub. Date: Aug. 13, 2026

(54) FORENSIC SANITATION AND RECOVERY OF FIRMWARE CONFIGURATION SERIAL PERIPHERAL INTERFACE PARTITION

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Amit Tiwari, Austin, TX (US)

(21) Appl. No.: 19/047,738

(22) Filed: Feb. 7, 2025

(51) Int. Cl. G06F 9/4401

(52) U.S. Cl. CPC G06F 9/4403; G06F 9/4411

(57) ABSTRACT

An information handling system include an embedded controller and a processor. In response to a basic input/output system (BIOS) update of the information handling system, the processor notifies the embedded controller of the BIOS update and proceeds to a first boot process of the information handling system subsequent to the BIOS update. During the first boot process, the system determines whether to perform a forensic cleanup subsequent to the BIOS update based on the notification to the embedded controller. During the first boot process, the system also cleans pre-boot driver configuration data in response to determining to perform the forensic cleanup. Afterward, the information handling system proceeds to a typical boot process.

### FIELD OF THE DISCLOSURE

The present disclosure generally relates to information handling systems, and more particularly relates to forensic sanitation and recovery of firmware configuration serial peripheral interface partition.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system include an embedded controller and a processor. In response to a basic input/output system (BIOS) update of the information handling system, the processor may notify the embedded controller of the BIOS update and proceed to a first boot process of the information handling system subsequent to the BIOS update. During the first boot process the system may determine whether to perform a forensic cleanup subsequent to the BIOS update based on the notification to the embedded controller. During the first boot process, the system also may clean pre-boot driver configuration data in response to a determination to perform the forensic cleanup. Afterward, the information handling system proceeds to a typical boot process.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system for forensic sanitation and recovery of firmware configuration serial peripheral interface partition, according to an embodiment of the present disclosure;

FIG. 2 is a flowchart of a method for forensic sanitation and recovery of firmware configuration serial peripheral interface partition, according to an embodiment of the present disclosure; and

FIG. 3 is a block diagram of an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

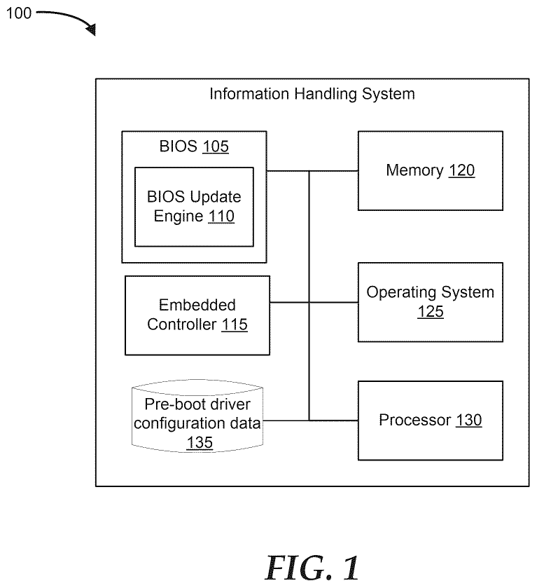

FIG. 1 illustrates a portion of an information handling system 100 for forensic sanitation and recovery of a firmware configuration serial peripheral interface (SPI) partition, according to an embodiment of the present disclosure. Information handling system 100 includes a basic input/output system (BIOS) 105, an embedded controller 115, a memory 120, an operating system 125, and a processor 130. BIOS 105 includes a BIOS update engine 110. BIOS 105 may be connected to embedded controller 115, embedded controller 115, memory 120, operating system 125, and processor 130. However, any variety of connections between BIOS 105 and the other components of information handling system 100 are envisioned as falling within the scope of the present disclosure. In addition, connections between these components may be omitted for descriptive clarity. Further, the operations described herein as being performed by BIOS 105, embedded controller 115, and operating system 125 may be performed or executed by processor 130.

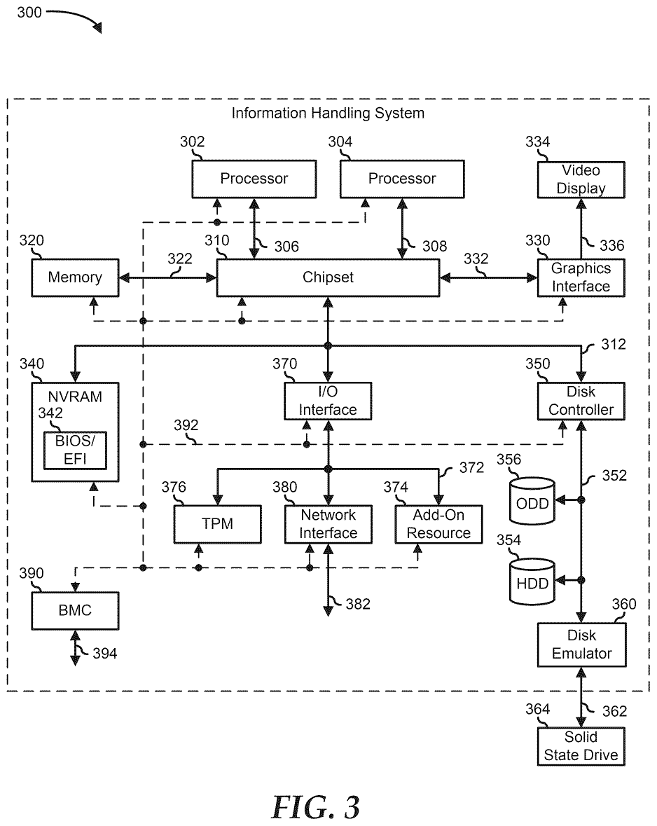

Information handling system 100, which is similar to information handling system 300 of FIG. 3, may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 100 may also be a portable information handling system that may include a laptop, a notebook, a smartphone, a tablet, or a personal digital assistant, among others.

BIOS 105, which is similar to a BIOS/extensible firmware interface (BIOS/EFI) 342 of FIG. 3, may include any system, device, or apparatus configured to identify, test, and/or initialize information handling resources of information handling system 100 and/or initialize interoperation of information handling system 100 with other information handling systems. “BIOS” may broadly refer to any system, device, or apparatus configured to perform such functionality, including without limitation a Unified Extensible Firmware Interface (UEFI). In some embodiments, the BIOS may be implemented as a program of instructions that may be read by and executed on processor 130 to carry out the functionality of BIOS 105. BIOS 105 may also include one or more firmware volumes and drivers.

In these and other embodiments, BIOS 105 may be configured to be the first code executed by processor 130 when information handling system 100 is booted and/or powered on. As part of its initialization functionality, code for BIOS 105 may be configured to set components of information handling system 100 into a known state, so that one or more applications, such as an operating system or other application programs, stored on compatible media may be executed by processor 130 and given control of information handling system 100. BIOS 105 may be embodied in its dedicated memory, such as memory 120 which is accessible to processor 130. For example, in some embodiments, BIOS 105 may be embodied in a non-volatile memory, such as a serial peripheral interface (SPI) flash memory.

In one scenario, a user may receive a notification to update BIOS 105 to cure a vulnerability, such as a vulnerability in pre-boot connectivity related to secure sockets layer (SSL) certificates. A BIOS update may include an upgrade to a newer BIOS version or a downgrade to an older BIOS version. In addition, the BIOS update may include upgrading or downgrading the drivers. A new BIOS version may fix the vulnerability but requires the user to manually remove the SSL certificates to protect the information handling system. In another scenario, after a user updates the BIOS, the user's information handling system experiences a “No power on self-test (POST)” state when the user tries to power on the information handling system. For example, the user may observe a logo on a display screen but is stuck without a progress wheel showing. At this point, the user may contact technical support, and a technical support agent may help the user recover the BIOS by downgrading the BIOS to a previous version. However, the information handling system now fails to boot. At this point, the user may take the information handling system to a service center.

In both of the above scenarios and other similar situations, the issue could be with information, such as configuration settings, stored in a data store associated with the BIOS not being compatible with the information associated with a newer version of the BIOS. The issue could also be that the information stored in the data store is stale after a BIOS upgrade or downgrade. In these scenarios, a user who is not technically knowledgeable generally calls a technical support agent or service center, which typically means that the user loses time and/or data. The manufacturer of the information handling system generally also incurs increased costs for support and possibly hardware replacement. To address these and other concerns, the present disclosure provides a system and method for forensic sanitation and recovery of a firmware configuration serial peripheral interface (SPI) partition.

In one embodiment, incoming drivers associated with the BIOS upgrade or downgrade may be configured to perform a forensic cleanup of previous state machines, stored configurations, and datasets. For example, if a new driver is aware of data format changes, the new driver may determine that a forensic cleanup may be needed in addition to applying the configuration changes. This may transform a stale state machine on a first boot after the BIOS update and avoid “No POST” issues, such as no power on power-on self-test (POST), no power, no video, and no boot, among others.

In one embodiment, BIOS update engine 110 may be configured to notify embedded controller 115 that there has been a BIOS version change during a BIOS update. The BIOS update may be an upgrade or a downgrade of a current version of BIOS 105. During an upgrade of the BIOS from a lower or older version to a higher or newer version, the upgraded drivers associated with the higher or newer version may be configured to be aware of forensic changes between the two versions. The forensic changes may include changes in configuration settings which include changes from a first number of parameters to a second number of parameters, such as from five parameters to six parameters or from six parameters to five parameters.

During the downgrade of the BIOS from a higher or newer version to a lower or older version, the downgraded drivers may not be aware of what stale state machine was left behind because of the downgrade. To mitigate this, during the first boot of the BIOS version, the driver may be configured to list the forensic changes to be applied if the BIOS was downgraded. To illustrate a particular example, assuming that the BIOS was downgraded from version 3.0 to version 2.0 during a recovery of the BIOS. Prior to the downgrade, when the BIOS version 3.0 was first booted, drivers associated with the BIOS version 3.0 may be configured to list forensic changes to be applied if the BIOS was downgraded to version 2.0 The cleanup may include reverting or accommodating the forensic changes and/or the changes in the configuration settings. For example, the cleanup may migrate the configuration data associated with a previous BIOS version installed in information handling system 100. For example, if the BIOS was downgraded from version 3.0 to version 2.0 and BIOS version 3.0 has “N” variables and BIOS version 2.0 has “N-1” variables, the cleanup may remove the extra variable.

During the BIOS upgrade, wherein the BIOS is upgraded from a lower version to a higher version, such as from version 2.0 to version 3.0, the upgraded drivers in version 3.0 may be aware of forensic changes to apply but in case of BIOS change, such as during a recovery leading to downgrading to a lower version, such as from version 2.0 to version 1.0, the incoming drivers typically do not know what stale state machine was left behind. To mitigate this gap, during the first boot of the current BIOS version, such as 2.0 in this example, each one of the drivers may generate a list of the forensic changes to be applied if the BIOS was downgraded, such as to version 1.0. This list may be stored in a non-volatile memory of embedded controller 115 and can be used by the lower driver version to perform a cleanup during the downgrade. The cleanup includes a forensic cleanup of a stale state machine and data stores so that incoming drivers can operate successfully and avoid no post and/or no video among others and address vulnerabilities. The cleanup may also include reverting or accommodating the forensic changes and/or the changes in the configuration settings. This can reduce service costs for the manufacturer. This may also save the user time and repair costs.

Embedded controller 115 may comprise any system, device, or apparatus configured to provide out-of-band management facilitates or management of information handling system 100. Such management may be made by embedded controller 115 even if information handling system 100 is powered off or powered to a standby state. Embedded controller 115 may include a processor, memory, and out-of-band network interface separate from and physically isolated from an in-band network interface of information handling system 100 and/or other embedded information handling resources. In certain embodiments, embedded controller 115 may include or may be an integral part of a BMC, management controller, service processor, or remote access controller. In one embodiment, embedded controller 115 may make a notification available to all drivers on the first boot and take data transformation actions. The notification in the embedded controller may be cleared at the end of a driver execution environment (DXE) phase during exit boot services by the BIOS. For example, the upgrade/downgrade flag or variable may be set to zero.

Memory 120, which is similar to memory 320 of FIG. 3, may be communicatively coupled to processor 130 and may include any system, device, or apparatus operable to retain program instructions or data for a period of time. Memory 120 may include a random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to information handling system 100 is turned off.

Operating system 125 may be a system software that manages computer hardware and software resources, such as Microsoft Windows®, Linux®, etc. In addition, operating system 125 may provide common services for computer programs. Processor 130, which is similar to processors 302 and 304 of FIG. 3, may include any system, device, or apparatus operable to interpret and/or execute program instructions and/or process data, and may include, without limitation, a microprocessor, microcontroller, digital signal processor, application specific integrated circuit (ASIC), or any other digital or analog circuitry configured to interpret, and/or execute program instructions and/or process data stored in memory and/or another component of information handling system.

Pre-boot driver configuration data 135 includes data associated with configuration settings of BIOS 105 and/or associated drivers. For example, the data may include pre-boot variables and values of firmware for pre-boot resources of information handling system 100. Pre-boot driver configuration data 135 may be stored in a non-volatile storage device, such as a partition of a serial peripheral interface.

Those of ordinary skill in the art will appreciate that the configuration, hardware, and/or software components of information handling system 100 depicted in FIG. 1 may vary. For example, the illustrative components within information handling system 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

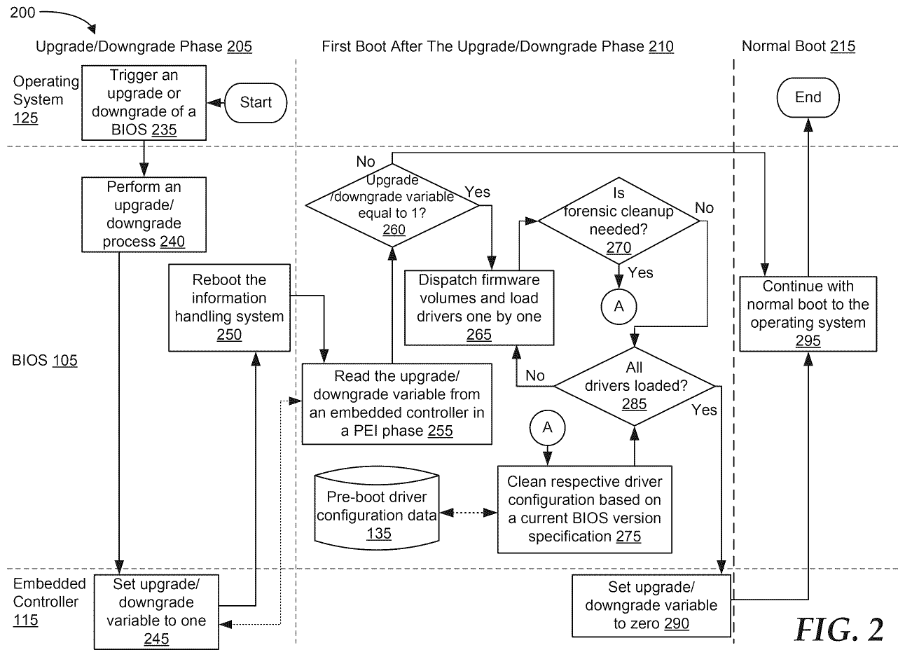

FIG. 2 illustrates a portion of a flowchart of a method 200 for forensic sanitation and recovery of a firmware configuration SPI partition, according to an embodiment of the present disclosure. In particular, method 200 may be utilized to forensically clean up stale state machine and data stores to make sure incoming drivers can operate successfully to avoid no post, no video, and address vulnerabilities, among others. Method 200 may be performed by any suitable component of information handling system 100 including, but not limited to, BIOS 105 and embedded controller 115 of FIG. 1. While embodiments of the present disclosure are described in terms of the components of information handling system 100 of FIG. 1, it should be recognized that other components may be utilized to perform the described method. It will be readily appreciated that not every method step set forth in this flow chart is always necessary and that certain steps of the methods may be combined, performed simultaneously, in a different order, or perhaps omitted, without varying from the scope of the disclosure. One of skill in the art will appreciate that this flow chart explains a typical example, which can be extended to applications or services in practice.

Method 200 includes several phases that include an upgrade/downgrade phase 205, a first boot after the upgrade/downgrade phase 210, and a normal boot phase 215. Upgrade/downgrade phase 205 includes blocks 235, 240, 250 and 245. The first boot after the upgrade/downgrade phase 210 includes decision blocks 26, 270, and 285 along with blocks 255, 265, 275, and 290. Normal boot phase 215 includes a block 295.

Method 200 typically starts at block 235 where a trigger for an upgrade or downgrade of BIOS 105 is received by operating system 125. The method may proceed to block 240 where the upgrade or downgrade process of BIOS 105 may be completed or performed. When updating the BIOS, new firmware volumes may be copied but not loaded until a next boot process. If a new driver or driver version, such as when upgraded or downgraded, is aware of forensic changes, such as data format changes and/or configuration setting changes, a forensic cleanup is needed and configuration changes to be performed to match what is expected by the new driver or driver version. As such, method 200 can transform a previous stale state machine on the first boot after the update.

The method may then proceed to block 245 where embedded controller 115 may set an upgrade/downgrade variable or flag to indicate that BIOS 105 has completed an upgrade or downgrade process. For example, the upgrade/downgrade variable or flag may be set to one. The upgrade/downgrade variable or flag value of one may indicate that an upgrade or downgrade process has been performed. Accordingly, the upgrade/downgrade value of zero may indicate that the upgrade or downgrade process has not been performed. The value associated with the upgrade/downgrade variable may be stored in a non-volatile memory or storage associated with embedded controller 115. The method may proceed to reboot the information handling system at block 250. At the first boot subsequent to the upgrade or downgrade process, the method may proceed to block 255 where BIOS 105 may read the value of the upgrade/downgrade variable stored in embedded controller 115 during a pre-EFI initialization (PEI) phase of the boot process. The method may proceed to decision block 260.

At decision block 260, BIOS 105 may determine whether the value of the upgrade/downgrade variable is equal to one. If the value of the upgrade/downgrade variable is equal to one, then the “YES” branch is taken, and the method may proceed to block 265. If the value of the upgrade/downgrade variable is not equal to one, then the “NO” branch is taken, and the method may proceed to block 295. At block 265, BIOS 105 may dispatch firmware volumes and load drivers one by one until all of applicable drivers are loaded. Each one of the drivers may also generate and maintain a list of forensic changes to be applied if BIOS 105 is downgraded to a previous version. This list of the forensic changes may be stored in a non-volatile memory associated with embedded controller 115. The list of the forensic changes may be utilized by a driver associated with the previous version of BIOS 105 during the downgrade during the forensic cleanup. The list of the forensic changes may indicate which variable and/or associated value of pre-boot driver configuration data 135 may be updated, such as migrated or cleaned up.

The method may proceed to decision block 270 where BIOS 105 may determine whether a forensic cleanup is needed at decision block 270. BIOS 105 or in particular a BIOS update engine, similar to BIOS update engine 110 of FIG. 1, may determine if there are forensic changes and/or changes in configuration settings by querying a non-volatile storage of a list provided by one or more drivers to embedded controller 115. If there are changes, then a forensic cleanup may be needed. If a forensic cleanup is needed, then the “YES” branch is taken, and the method may proceed to block 275. If a forensic cleanup is not needed, then the “NO” branch is taken, and the method may proceed to decision block 285. At decision block 285, BIOS 105 may determine whether the applicable drivers have been loaded. If the drivers have been loaded, then the “YES” branch is taken, and the method may proceed to block 290. If the drivers have not loaded, then the “NO” branch is taken, and the method may proceed to block 265.

At block 275, BIOS 105 may perform a forensic cleanup, such as respective a pre-boot driver configuration data 135 based on a specification of a current BIOS version and/or associated driver. Pre-boot driver configuration data 135 may have been stored in a non-volatile storage device or memory associated with BIOS 105. Pre-boot driver configuration data 135 may include the forensic changes and/or the changes in the configuration settings. During the forensic cleanup, BIOS 105 and/or a driver may update pre-boot driver configuration data 135 based on the list of the forensic changes to match current expectations of the current BIOS and/or associated driver. The update of pre-boot driver configuration data 135 may include removing or adding parameters. For example, the forensic cleanup may remove one or more parameters that may not be needed or utilized by the current BIOS version. The current BIOS version installed in the information handling system may be an upgrade or a downgrade of a BIOS version. In another example, the forensic cleanup may add one or more parameters that may be needed or utilized by the current BIOS version. The parameters may include a variable and corresponding value.

Prior to performing the cleanup, BIOS 105 may identify the forensic changes from the list maintained by BIOS 105 and/or each associated driver. The method may proceed to block 295. At block 290, embedded controller 115 may clear the upgrade/downgrade variable, such as setting the value of the upgrade/downgrade variable to zero. This may indicate that the forensic cleanup has been performed. The method may proceed to block 295 where BIOS 105 may continue with a typical boot process, wherein the information handling system may be booted to operating system 125.

FIG. 3 illustrates an embodiment of an information handling system 300 including processors 302 and 304, a chipset 310, a memory 320, a graphics adapter 330 connected to a video display 334, a non-volatile RAM (NVRAM) 340 that includes a basic input and output system/extensible firmware interface (BIOS/EFI) module 342, a disk controller 350, a hard disk drive (HDD) 354, an optical disk drive (ODD) 356, a disk emulator 360 connected to a solid-state drive (SSD) 364, an I/O interface 370 connected to an add-on resource 374 and a trusted platform module (TPM) 376, a network interface 380, and a BMC 390. Processor 302 is connected to chipset 310 via processor interface 306, and processor 304 is connected to the chipset via processor interface 308. In a particular embodiment, processors 302 and 304 are connected together via a high-capacity coherent fabric, such as a HyperTransport link, a QuickPath Interconnect, or the like. Chipset 310 represents an integrated circuit or group of integrated circuits that manage the data flow between processors 302 and 304 and the other elements of information handling system 300. In a particular embodiment, chipset 310 represents a pair of integrated circuits, such as a northbridge component and a southbridge component. In another embodiment, some or all of the functions and features of chipset 310 are integrated with one or more of processors 302 and 304.

Memory 320 is connected to chipset 310 via a memory interface 322. An example of memory interface 322 includes a DDR memory channel and memory 320 represents one or more DDR DIMMs. In a particular embodiment, memory interface 322 represents two or more DDR channels. In another embodiment, one or more of processors 302 and 304 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 320 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 330 is connected to chipset 310 via a graphics interface 332 and provides a video display output 336 to a video display 334. An example of a graphics interface 332 includes a PCIe interface and graphics adapter 330 can include a four-lane (x4) PCIe adapter, an eight-lane (x8) PCIe adapter, a 16-lane (x16) PCIe adapter, or another configuration, as needed or desired. In a particular embodiment, graphics adapter 330 is provided down on a PCB. Video display output 336 can include a Digital Video Interface (DVI), a High-Definition Multimedia Interface (HDMI), a DisplayPort interface, or the like, and video display 334 can include a monitor, a smart television, an embedded display such as a laptop computer display, or the like.

NVRAM 340, disk controller 350, and I/O interface 370 are connected to chipset 310 via an I/O channel 312. An example of I/O channel 312 includes one or more point-to-point PCIe links between chipset 310 and each of NVRAM 340, disk controller 350, and I/O interface 370. Chipset 310 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 340 includes BIOS/EFI module 342 that stores machine-executable code (BIOS/EFI code) that operates to detect the resources of information handling system 300, to provide drivers for the resources, to initialize the resources, and to provide common access mechanisms for the resources. The functions and features of BIOS/EFI module 342 will be further described below.

Disk controller 350 includes a disk interface 352 that connects the disc controller to a hard disk drive (HDD) 354, to ODD 356, and to disk emulator 360. An example of disk interface 352 includes an Integrated Drive Electronics (IDE) interface, an Advanced Technology Attachment (ATA) such as a parallel ATA (PATA) interface or a SATA interface, a SCSI interface, a USB interface, a proprietary interface, or a combination thereof. Disk emulator 360 permits SSD 364 to be connected to information handling system 300 via an external interface 362. An example of external interface 362 includes a USB interface, an institute of electrical and electronics engineers (IEEE) 1394 (Firewire) interface, a proprietary interface, or a combination thereof. Alternatively, SSD 364 can be disposed within information handling system 300.

I/O interface 370 includes a peripheral interface 372 that connects the I/O interface to add-on resource 374, to TPM 376, and to network interface 380. Peripheral interface 372 can be the same type of interface as I/O channel 312 or can be a different type of interface. As such, I/O interface 370 extends the capacity of I/O channel 312 when peripheral interface 372 and the I/O channel are of the same type, and the I/O interface translates information from a format suitable to the I/O channel to a format suitable to the peripheral interface 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board, or add-in card disposed within information handling system 300, a device that is external to the information handling system, or a combination thereof.

Network interface 380 represents a network communication device disposed within information handling system 300, on a main circuit board of the information handling system, integrated onto another component such as chipset 310, in another suitable location, or a combination thereof. Network interface 380 includes a network channel 382 that provides an interface to devices that are external to information handling system 300. In a particular embodiment, network channel 382 is of a different type than peripheral interface 372 and network interface 380 translates information from a format suitable to the peripheral channel to a format suitable to external devices.

In a particular embodiment, network interface 380 includes a NIC or host bus adapter (HBA), and an example of network channel 382 includes an InfiniBand channel, a Fibre Channel, a Gigabit Ethernet channel, a proprietary channel architecture, or a combination thereof. In another embodiment, network interface 380 includes a wireless communication interface, and network channel 382 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 382 can be connected to an external network resource (not illustrated). The network resource can include another information handling system, a data storage system, another network, a grid management system, another suitable resource, or a combination thereof.

BMC 390 is connected to multiple elements of information handling system 300 via one or more management interface 392 to provide out-of-band monitoring, maintenance, and control of the elements of the information handling system. As such, BMC 390 represents a processing device different from processor 302 and processor 304, which provides various management functions for information handling system 300. For example, BMC 390 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 390 can vary considerably based on the type of information handling system. BMC 390 can operate in accordance with an Intelligent Platform Management Interface (IPMI). Examples of BMC 390 include an Integrated Dell® Remote Access Controller (iDRAC).

Management interface 392 represents one or more out-of-band communication interfaces between BMC 390 and the elements of information handling system 300 and can include an Inter-Integrated Circuit (I²C) bus, a System Management Bus (SMBus), a Power Management Bus (PMBUS), a Low Pin Count (LPC) interface, a serial bus such as a Universal Serial Bus (USB) or a SPI, a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 302 and 304 and procedures that are implemented on the information handling system in response to the executed code.

BMC 390 operates to monitor and maintain system firmware, such as code stored in BIOS/EFI module 342, option ROMs for graphics adapter 330, disk controller 350, add-on resource 374, network interface 380, or other elements of information handling system 300, as needed or desired. In particular, BMC 390 includes a network interface 394 that can be connected to a remote management system to receive firmware updates, as needed or desired. Here, BMC 390 receives the firmware updates, stores the updates to a data storage device associated with the BMC, and transfers the firmware updates to NVRAM 340 of the device or system that is the subject of the firmware update, thereby replacing the currently operating firmware associated with the device or system, and reboots information handling system, whereupon the device or system utilizes the updated firmware image.

BMC 390 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 390, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 390 is included on a main circuit board (such as a baseboard, a motherboard, or any combination thereof) of information handling system 300 or is integrated onto another element of the information handling system such as chipset 310, or another suitable element, as needed or desired. As such, BMC 390 can be part of an integrated circuit or a chipset within information handling system 300. An example of BMC 390 includes an iDRAC, or the like. BMC 390 may operate on a separate power plane from other resources in information handling system 300. Thus BMC 390 can communicate with the management system via network interface 394 while the resources of information handling system 300 are powered off. Here, information can be sent from the management system to BMC 390 and the information can be stored in a RAM or NVRAM associated with the BMC. Information stored in the RAM may be lost after power-down of the power plane for BMC 390, while information stored in the NVRAM may be saved through a power-down/power-up cycle of the power plane for the BMC.

Information handling system 300 can include additional components and additional buses, not shown for clarity. For example, information handling system 300 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 300 can include multiple CPUs and redundant bus controllers. One or more components can be integrated together. Information handling system 300 can include additional buses and bus protocols, for example, I²C and the like. Additional components of information handling system 300 can include one or more storage devices that can store machine-executable code, one or more communications ports for communicating with external devices, and various input and output (I/O) devices, such as a keyboard, a mouse, and a video display.

For purposes of this disclosure, information handling system 300 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 300 can include processing resources for executing machine-executable code, such as processor 302, a programmable logic array (PLA), an embedded device such as a System-on-a-Chip (SoC), or other control logic hardware. Information handling system 300 can also include one or more computer-readable media for storing machine-executable code, such as software or data.

Although FIG. 2 shows example blocks of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an ASIC, a Field Programmable Gate Array (FPGA), a structured ASIC, or a device embedded on a larger chip), a card (such as a Peripheral Component Interface (PCI) card, a PCI-express card, a PCMCIA card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
in response to a basic input/output system (BIOS) update of an information handling system, by a processor, notifying an embedded controller of the BIOS update;
proceeding to a first boot process of the information handling system subsequent to the BIOS update, wherein the first boot process includes:
determining whether to perform a forensic cleanup subsequent to the BIOS update based on the notifying of the embedded controller; and
in response to determining to perform the forensic cleanup, updating pre-boot driver configuration data; and
booting the information handling system.

2. The method of claim 1, further comprising generating a list of forensic changes.

3. The method of claim 2, wherein the list of the forensic changes is stored in a memory associated with the embedded controller.

4. The method of claim 2, wherein the updating of the pre-boot driver configuration data is based on the list of the forensic changes.

5. The method of claim 1, wherein the notifying of the embedded controller regarding the BIOS update includes updating a value of an upgrade variable.

6. The method of claim 1, further comprising loading drivers subsequent to the updating of the pre-boot driver configuration data.

7. The method of claim 6, further comprising clearing a value of an upgrade variable subsequent to the loading of the drivers.

8. The method of claim 1, further comprising dispatching firmware volumes of the BIOS subsequent to the updating of the pre-boot driver configuration data.

9. An information handling system, comprising:
a processor; and
a memory coupled to the processor, the memory having program instructions stored thereon that upon execution cause the processor to:
in response to a basic input/output system (BIOS) update of the information handling system, notify an embedded controller of the BIOS update;
proceed to a first boot process of the information handling system subsequent to the BIOS update, wherein the first boot process includes to:
determine whether to perform a forensic cleanup subsequent to the BIOS update based on the notification to the embedded controller; and
in response to a determination to perform the forensic cleanup, update pre-boot driver configuration data; and
boot the information handling system.

10. The information handling system of claim 9, where the program instructions further cause the processor to generate a list of forensic changes.

11. The information handling system of claim 10, wherein the list of the forensic changes is stored in another memory coupled to the embedded controller.

12. The information handling system of claim 10, wherein the update of the pre-boot driver configuration data is based on the list of the forensic changes.

13. The information handling system of claim 9, wherein the notify of the embedded controller regarding the BIOS update includes update of a value of an upgrade variable.

14. A non-transitory computer-readable medium to store instructions that are executable to perform operations comprising:
in response to a basic input/output system (BIOS) update of an information handling system, notifying an embedded controller of the BIOS update;
proceeding to a first boot process of the information handling system subsequent to the BIOS update, wherein the first boot process includes:
determining whether to perform a forensic cleanup subsequent to the BIOS update based on the notifying of the embedded controller; and
in response to determining to perform the forensic cleanup, updating pre-boot driver configuration data; and
booting the information handling system.

15. The non-transitory computer-readable medium of claim 14, wherein the operations further comprise generating a list of forensic changes.

16. The non-transitory computer-readable medium of claim 15, wherein the list of the forensic changes is stored in a memory associated with the embedded controller.

17. The non-transitory computer-readable medium of claim 15, wherein the updating of the pre-boot driver configuration data is based on the list of the forensic changes.

18. The non-transitory computer-readable medium of claim 14, wherein the notifying of the embedded controller regarding the BIOS update includes updating a value of an upgrade variable.

19. The non-transitory computer-readable medium of claim 14, wherein the operations further comprise loading drivers subsequent to the cleaning of the pre-boot driver configuration data.

20. The non-transitory computer-readable medium of claim 14, wherein the operations further comprise dispatching firmware volumes of the BIOS subsequent to the cleaning of the pre-boot driver configuration data.
